(19) United States
(12) Patent Application Publication
(10) Pub. No.: US 2010/0250309 A1
(43) Pub. Date: Sep. 30, 2010

(54) ASSET MANAGEMENT SYSTEM AND METHOD FOR AN AUTOMOTIVE VEHICLE

(75) Inventors: Edward Andrew Pleet, Livonia, MI (US); William M. Frykman, Birmingham, MI (US); Matthew Whitaker, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/744,092

(22) PCT Filed: Sep. 2, 2008
(86) PCT No.: PCT/US08/75004

§ 371 Date: May 21, 2010

Related U.S. Application Data
(60) Provisional application No. 61/005,279, filed on Dec. 4, 2007.

(51) Int. Cl. G06Q 10/00; H04Q 5/22

(52) U.S. Cl. 705/7; 340/10.1

(57) ABSTRACT

An asset management system identifies assets required for a selected task and determines whether those assets are in a vicinity of a vehicle. The assets include wireless identification tags. The system includes one or more radio frequency transmitters and receivers, a processor and an interface. The interface may be remote from the vehicle.

### CROSS-REFERENCE TO RELATED APPLICATIONS

This application claims the benefit of U.S. Provisional Application No. 61/005,279 filed Dec. 4, 2007.

### BACKGROUND

1. Field of the Invention

The invention relates to systems and methods for selecting and tracking tools and other tangible assets.

2. Background Art

Several systems and techniques are known for electronically monitoring material assets. U.S. Pat. No. 7,151,454 to Washington is an example. Washington provides systems and methods that may be employed to visually locate and/or track objects equipped with active RFID tags. The systems and methods may employ an articulated camera(s), such as closed circuit television (“CCTV”) or other suitable type of articulated camera(s), that is equipped with an antenna array.

U.S. Pat. No. 7,138,916 to Schwartz et al. is another example. Schwartz et al. provides a computerized system to inventory articles, to locate lost or stolen articles and to recover a lost or stolen article. The system applies an electronic tag to each article of a multiplicity of articles or only to a valuable article and employs a computer to maintain an inventory of all articles. Use is made of a global positioning system to locate a lost or stolen article as well as to track movements of the article. A history of the movement of the article may also be plotted on a map. An electronic geographic boundary area may also be placed around an article that can be used to emit a signal indicative of the article leaving the area.

U.S. Pat. No. 7,123,149 to Nowak et al. is yet another example. Nowak et al. provides an integrated system for tracking assets (tools and materials) and personnel associated with a work site. Personnel are equipped with tracking devices having at least geo-location capability. Assets are tagged with RFID tags, which are interrogated at portals, by mobile scanners, or by personnel tracking devices having RFID reading capability. The tag readers and tracking devices are all in communication with a common “information backbone” and all data is delivered to, and processed by, a common command and control subsystem.

### SUMMARY

An asset management system for an automotive vehicle includes a detection module configured to detect signals from wireless identification tags associated with assets in a vicinity of the vehicle. The signals are indicative of identifiers embedded in the wireless identification tags. The system also includes a processor module configured to (i) identify assets to perform a specified task and (ii) determine whether each of the assets to perform the specified task is located within the vicinity of the vehicle based on the identifiers. The system further includes an interface module configured to (i) receive input specifying one or more assets for one or more tasks, (ii) receive input specifying a task and (iii) provide output indicating whether the assets to perform the specified task are located within the vicinity of the vehicle, as determined by the processor module.

A method for locating assets to perform a task in a vicinity of a vehicle includes receiving input specifying one or more assets to one or more tasks, receiving input specifying a task, and detecting signals from wireless identification tags associated with assets in a vicinity of a vehicle. The signals are indicative of identifiers embedded in the wireless identification tags. The method also includes determining whether each of the assets to perform the specified task is located within the vicinity of the vehicle based on the identifiers, and providing output indicating whether the assets to perform the specified task are located within the vicinity of the vehicle.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic diagram of an exemplary asset management system according to certain embodiments of the invention.

FIG. 2 is a schematic diagram of an exemplary user interface of the system of FIG. 1.

FIG. 3 is a schematic diagram of portions of the system of FIG. 1.

FIG. 4 is a schematic diagram of an exemplary data structure utilized by the system of FIG. 1.

FIG. 5 is a schematic diagram of another exemplary user interface of the system of FIG. 1.

FIG. 6 is a schematic diagram of another exemplary data structure utilized by the system of FIG. 1.

FIG. 7 is a schematic diagram of yet another exemplary user interface of the system of FIG. 1.

FIG. 8 is a schematic diagram of yet another exemplary data structure utilized by the system of FIG. 1.

FIG. 9 is a flow chart of an exemplary method for automatically selecting and tracking tools according to certain embodiments of the invention.

FIG. 10 is a schematic diagram illustrating the flow of data during the execution of a portion of the method of FIG. 9.

FIG. 11 is a schematic diagram illustrating the flow of data during the execution of another portion of the method of FIG. 9.

### DETAILED DESCRIPTION

The selecting and tracking of various assets, e.g., tools, materials, etc., used for construction jobs may be a time consuming and tedious task. Any one job may require a number of different tools. As an example, a house framing may require a nail gun, circular saw, hammer and measuring tape. As another example, a cement pouring may require buckets, molds and a mixer. The complexity and time associated with the selecting and tracking of tools and other assets may be increased under circumstances where multiple crews and vehicles are assigned differing jobs by a few individuals. As an example, assigning each crew to a particular job and ensuring that each crew is outfitted with the necessary tools and materials may take a considerable amount of time.

A member of a construction crew may make a mental list and visual inspection of the tools loaded on their vehicle before going to or leaving from a work site to ensure they have all the necessary tools. Such mental lists and visual inspections may be inadequate especially under circumstances where a great number of tools and materials are required. A tool that is found to be missing, when needed, may affect the efficiency of the crew performing the job.

Embodiments of the invention may be configured to select and/or track assets, such as tools, raw materials, machines, etc., for a task. In some embodiments, a vehicle is equipped with an interface that permits a user to select a task and that outputs a list of assets necessary to perform that task. The vehicle then indicates whether the necessary assets are within a vicinity of the vehicle. In other embodiments, a user in one vehicle may assign a task to a worker or crew associated with another vehicle and may also query the other vehicle as to whether or not the assets necessary to perform the task are in that vehicle. The other vehicle then issues a report in response to the query. In still other embodiments, a user may remotely assign tasks to different crews with different vehicles. The user may further remotely determine which vehicles or whether selected vehicles have the assets necessary to perform the task(s) assigned.

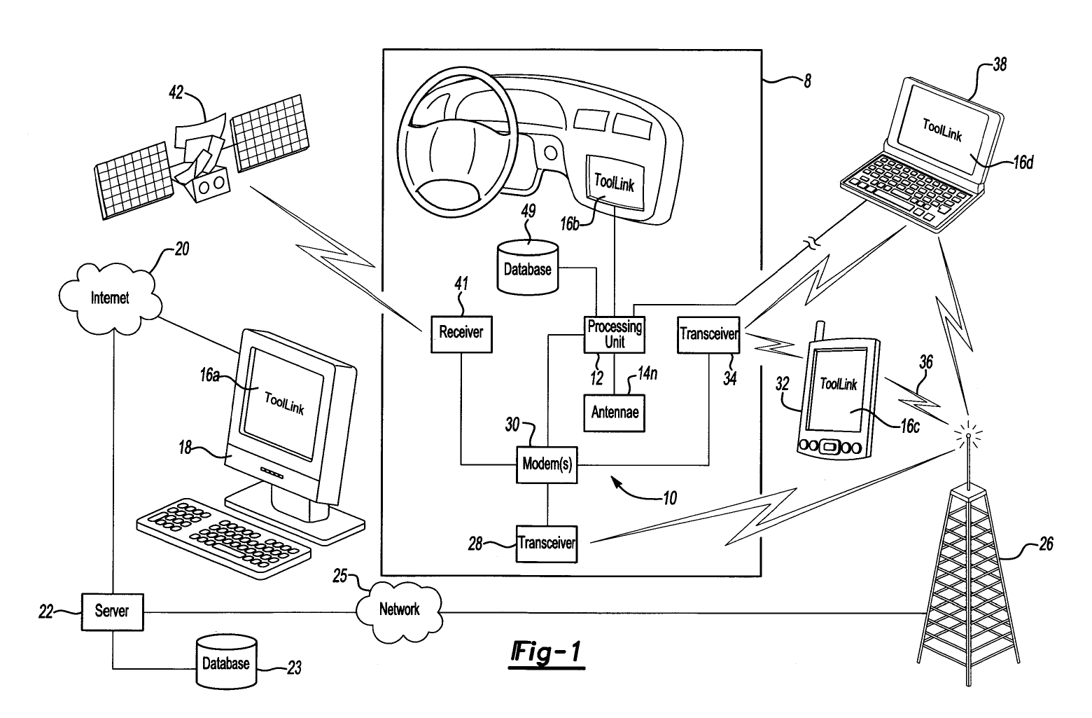

Referring now to FIG. 1, a vehicle 8 includes an asset selecting and tracking system 10. The system 10 includes a computer data processing unit 12 in communication with antennae 14n. A receiver, transmitter or transceiver (not shown) may be the interface between the processing unit 12 and antennae 14n. The antennae 14n enable communication with wireless asset tracking technology. As an example, under the command of the processing unit 12, the antennae 14n may generate signals in the radio frequency spectrum. The signals may excite circuitry in the form of radio frequency identification (RFID) tags affixed to various tools or other assets. The excited circuitry may generate response signals in the radio frequency spectrum for detection by the antennae 14n and processing by the processing unit 12.

In some embodiments, such as the embodiment of FIG. 1, the processing unit 12 and antennae 14n reside within a vehicle. In other embodiments, the processing unit 12 resides within a vehicle and the antennae 14n reside within a trailer, tool box or other location remote from the vehicle. In still other embodiments, the processing unit 12 resides within a location remote from the vehicle and the antennae 14n reside within the vehicle. Other arrangements are also possible.

In the embodiment of FIG. 1, a computer 18 and the system 10 may communicate via a communication link facilitated by an Internet 20, server 22, network 25 (such as the public switched telephone network or PSTN), cellular network 26, cellular transceiver 28 and modem(s) 30. As an example, information from the computer 18 passes through the Internet 20 before it is received at the server 22. The server 22 is configured with software that permits the computer 18 to access the system 10. The server 22 stores and retrieves data from a database 23. Information from the server 22 may be transmitted to the cellular network 26 via the network 25. The cellular network 26 may then broadcast the information, depending on the communication technique. Signals received by the cellular transceiver 28 may be demodulated at the modem(s) 30 before processing by the processing unit 12.

A cell phone 32 and the system 10 may communicate via a communication link facilitated by a radio frequency transceiver 34, such as a BLUETOOTH transceiver. As an example, information transmitted by the cell phone 32 is received by the transceiver 34 and demodulated by the modem(s) 30 before processing by the processing unit 12. Outgoing information may also be communicated to the cellular network 26 via the cell phone 32 at link 36. Alternatively, the modem(s) 30 and cellular transceiver 28 may be integrated with the system 10 for communication with the cellular network 26.

A mobile computer 38 and the system 10 may communicate via a wireless communication link facilitated by the transceiver 34. As an example, information transmitted by the mobile computer 38 is received by the transceiver 34 and demodulated by the modem(s) 30 before processing by the processing unit 12. As another example, the mobile computer 38 and the system 10 may communicate over a hard wire communication link via ETHERNET or Universal Serial Bus (USB).

The system 10 may be accessed from any of exemplary interfaces 16a-16d associated with the computer 18, vehicle 8, cell phone 32 and mobile computer 38 respectively. As an example, a foreman accessing the system 10 via the interface 16a may query the vehicle 8 as to its location. The system 10 may access an on-board navigation system that includes a receiver 41 capable of receiving signals from a satellite 42 that permit the processing unit 12 to determine its geographic location based on the received signals. The system 10 then responds to the query from the foreman with the geographic location information. The foreman may then assign a job to a construction crew using or otherwise associated with the vehicle 8. In response, the system 10 performs a scan of the vehicle 8 to determine whether some or all required assets are present and/or missing. The system 10 informs the foreman of the presence of the assets. Alternatively, the system 10 may instruct the construction crew, via the interface 16b, of present/missing assets, or to acquire the missing assets. The system 10 may also inform a supervisor, via the interface 16c, that the foreman has assigned the construction crew using the vehicle 8 a particular job and that the vehicle 8 includes or is missing certain assets required to perform the job.

As another example, a crew chief accessing the system 10 via the interface 16b may query a fleet of vehicles, each equipped with its own asset selecting and tracking system, regarding whether they have the required assets to perform a selected job. In response, each of the fleet vehicles performs its own scan of the assets within its vicinity and reports the results of the scan to the server 22 for access by the crew chief via the interface 16b.

As still yet another example, a construction worker accessing the system 10 via the interface 16b may select a job to be performed that day. The selected job information is communicated to a remote processing unit, such as the server 22, via the communication techniques described above. The server 22 determines the required assets for the job. The required asset information is then communicated to the vehicle 8 along with a command to activate the antennae 14n to scan the vehicle 8. The results of the scan are communicated back to the server 22. The server 22 determines if any required assets are missing. This information is communicated to the vehicle 8 and displayed via the display 16b. Other scenarios are also possible.

The system 10 may identify assets for a selected job and monitor whether those assets are within a vicinity of the antennae 14n. If any of the assets within the vicinity of the antennae 14n “leave” the vicinity of the antennae 14n, the system 10 may alert a user. As an example, the system 10 may send a message to the cell phone 32, either by the cellular network 26 or BLUETOOTH, indicating that a tool has left the vicinity of the antennae 14n. As another example, the system 10 may activate an alarm system associated with the vehicle 8. As yet another example, a paging signal may be communicated to a key fob (not shown) associated with the vehicle 8.

The system 10 may also periodically inventory the assets that are within a vicinity of the antennae 14n and compare that inventory to inventories taken at other times. If the system 10 detects differences between the inventories, the system 10 may alert a user. As an example, the system 10 may send a message to the computer 18 indicating that there are differences between an earlier and later performed inventory. This may be performed, for example, when leaving a job site to ensure that no tools are inadvertently left behind.

Inventories may be performed at specified intervals or upon the occurrence of specified events. As an example, a user may configure the system 10 to perform an inventory once every hour and at vehicle start up. As another example, the system 10 may perform an inventory in response to a user pressing a button on a key fob or console of the vehicle 8. Such configuration information may be entered via any of the interfaces 16a-16d.

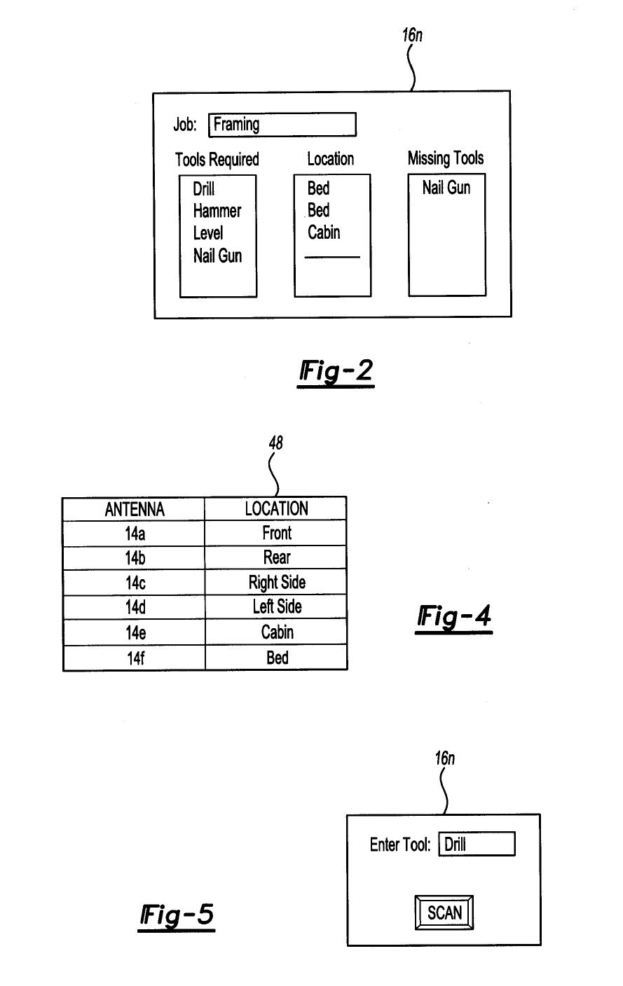

Referring now to FIG. 2, a “Framing” job has been entered into one of the interfaces 16n. In response, the system 10 has identified a “Drill,” “Hammer,” “Level” and “Nail Gun” as predefined assets required for the “Framing” job. The system 10 has also identified that the “Drill” and “Hammer” are currently located in a “Bed” of the vehicle 8 and that the “Level” is currently located in a “Cabin” of the vehicle 8. The system 10 has further identified that the “Nail Gun” is missing.

In other embodiments, the information of FIG. 2 may be displayed for multiple vehicles. As an example, a user of the computer 18 may access a fleet of vehicles equipped with asset selecting and tracking systems, such as the system 10 of FIG. 1, to assign jobs and query each vehicle as to whether it has the required assets to perform the assigned job. The server 22, acting as a communication hub with the fleet of vehicles, collects the asset information from each of the fleet vehicles and stores it in the database 23. The server 22 may then create a master view of the fleet vehicles on a single screen, e.g., the display 16a, that shows, for each vehicle, the assigned job and required, present and missing asset information.

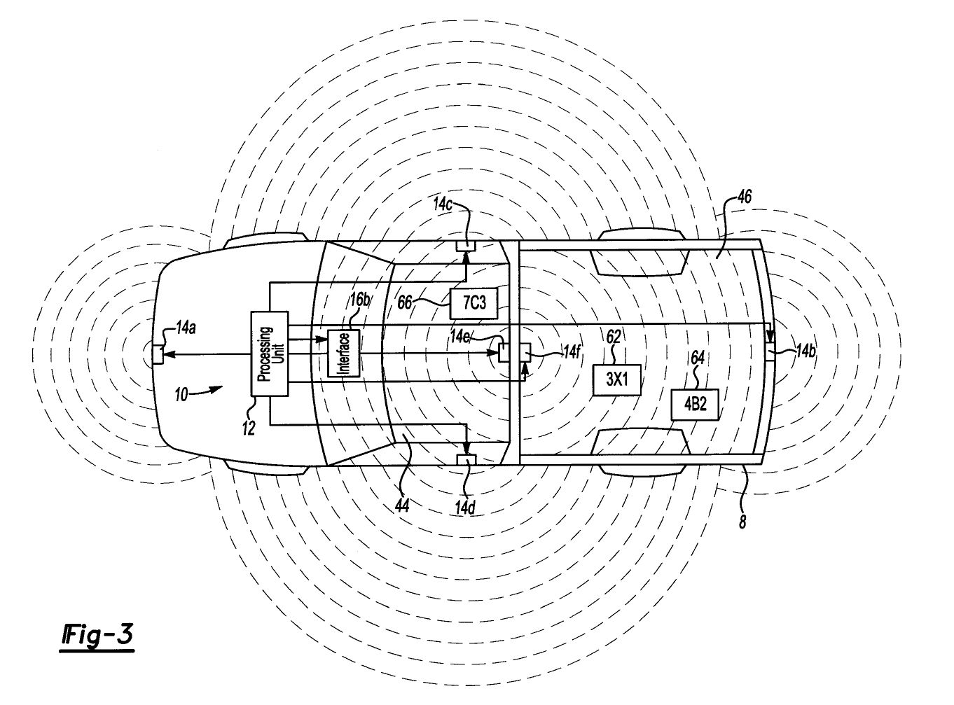

Referring now to FIG. 3, the antennae 14a-14f are positioned throughout the vehicle 8. The antennae 14a and 14b are positioned to monitor the front and rear of the vehicle 8 respectively. The antennae 14c and 14d are positioned to monitor respective sides of the vehicle 8. The antenna 14e is positioned to monitor a cabin 44 of the vehicle 8. The antenna 14f is positioned to monitor a bed 46 of the vehicle 8. In other embodiments, the antennae 14n may be positioned as desired. As an example, one of the antennae 14n may be removed from the vehicle 8 and placed, for example, at a work site.

Referring now to FIG. 4, a data structure 48 stored within a memory 49 of the processing unit 12 maps each of the antennae 14n with a respective location about the vehicle 8 (or jobsite, if remote antennae are used). In the example of FIG. 4, the antenna 14a monitors the front of the vehicle 8, the antenna 14b monitors the rear of the vehicle 8 and so on. The data structure 48 allows the system 10 to translate between a signal received from one of the antennae 14n and its location about the vehicle 8.

Referring again to FIG. 3, the antennae 14n have a communication module for communicating with the processing unit 12 via a controller area network (CAN). Commands from the processing unit 12 and responses from the antennae 14n are broadcast on the CAN for receipt by the antennae 14n and processing unit 12 respectively. In other examples, the processing unit 12 and antennae 14n may communicate directly via a hard wire connection. In still other examples, the processing unit 12 and antennae 14n may communicate via a wireless connection. Such wireless connections may be particularly suitable for antennae 14n configured to be removed from the vehicle 8 and placed, for example, at a work site. Such wireless connections may also be particularly suitable for circumstances where the processing unit 12 is remote from the vehicle 8.

Referring now to FIG. 5, a set-up mode allows a user to configure the system 10 to recognize a certain set of assets tagged with wireless identification tags. The interface 16n prompts the user to enter a description of an asset with such a tag. In the example of FIG. 5, the user has entered “Drill.” The user then places the “Drill” in the vehicle 8 and selects the “SCAN” button on the interface 16n. The user continues this process until all assets have been entered. In other embodiments, the interface 16n may prompt the user to enter a tagged asset and an identification code associated with the tagged asset, thus avoiding the scanning step. In still other embodiments, the user may be prompted to enter an identification code associated with a tagged asset and to select, from a list, a description of an asset to be associated with the identification code. Other configuration methods are also possible.

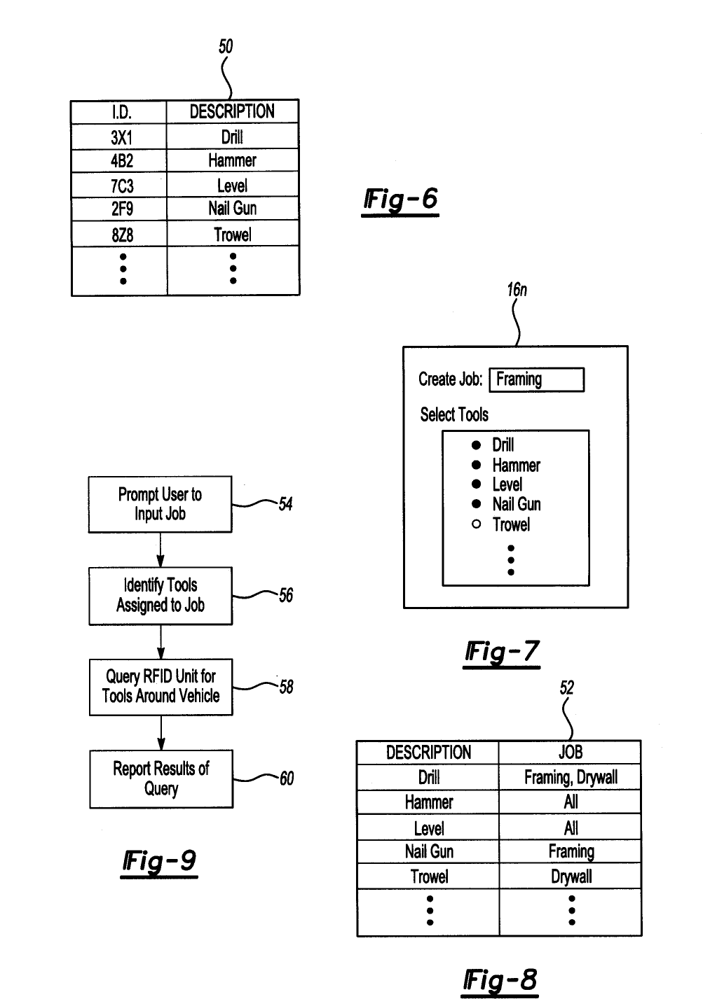

Referring now to FIG. 6, the system 10 creates a data structure 50 that maps each of the identification codes of the tags with its respective asset description as a result of the process described with reference to FIG. 5. The data structure 50 is stored in the memory 49 of the processing unit 12. In the example of FIG. 6, the identification code “3X1” corresponds to the “Drill,” the identification code “4B2” corresponds to the “Hammer” and so on. The data structure 50 allows the system 10 to translate between the identification codes and the asset descriptions.

Referring now to FIG. 7, the set-up mode also allows the user to configure the system 10 to identify assets necessary for a given job. The system 10 prompts the user, via the interface 16n, to enter a job. In the example of FIG. 7, the user has entered “Framing.” The interface 16n provides a set of assets that may be selected by the user. In the example of FIG. 7, the user has selected the “Drill,” “Hammer,” “Level” and “Nail Gun” by clicking on the circular fields provided. The user continues this process until all the jobs have been created. In other embodiments, the interface 16n may prompt the user to enter a job and a set of assets required for that job. In still other embodiments, the system 10 may be pre-loaded with a set of jobs and associated assets. These pre-loaded settings may be modified by the user. Other configuration methods are also possible.

Referring now to FIG. 8, the system 10 creates a data structure 52 that maps each of the asset descriptions with its respective job as a result of the process described with reference to FIG. 7. The data structure 52 is stored in the memory 49 of the processing unit 12 or alternatively, in the database 23 of the server 22 illustrated in FIG. 1. In the example of FIG. 8, the “Drill” corresponds to the jobs “Framing” and “Drywall,” the “Hammer” corresponds to “All” jobs and so on. The data structure 52 allows the system 10 to translate between the asset descriptions and the jobs.

Referring now to FIG. 9, a user may access the system 10 to determine whether the assets required for a particular job are in a vicinity of the vehicle 8. At step 54 the user is prompted to input a job into the system 10. At step 56, the system identifies assets assigned to the job input at step 54. At step 58, the system inquires as to the assets in the vicinity of the vehicle 8. At step 60, results of the inquiry are reported the user.

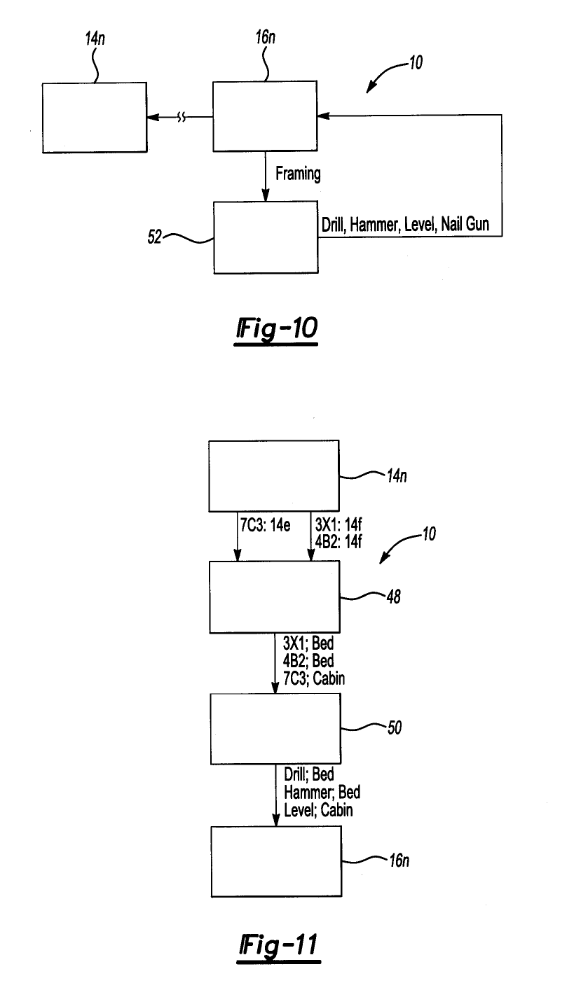

Referring now to FIG. 10, the job “Framing” has been input into the system 10 via the interface 16n. The system 10 identifies the assets required for the job “Framing” via the data structure 52. The system 10 also determines which assets, if any, are in a vicinity of the vehicle 8 by activating the antennae 14n.

Referring again to FIG. 3, the antennae 14n transmit signals (as indicated by dashed lines) capable of exciting circuitry associated with any wireless identification tags. In the embodiment of FIG. 3, tools 62, 64, 66 having tags with the identification codes “3X1,” “4B2” and “7C3” respectively are in a vicinity of the vehicle 8. In response to the signals transmitted by the antennae 14n, the circuitry associated with each of the tags of the tools 62, 64, 66 generate a response signal indicative of their identification code. As an example, the circuitry associated with the tag of the tool 62 generates a response signal indicative of the identification code “3X1.”

As explained above, each of the antennae 14n are tuned to monitor a specified region about the vehicle 8. As an example, the antenna 14e is tuned to monitor the cabin 44 of the vehicle 8 and the antenna 14f is tuned to monitor the bed 46 of the vehicle 8. Because of the location of the tools 62, 64, 66, the antenna 14f receives the response signals generated by the tags of the tools 62, 64 and the antenna 14e receives the response signal generated by the tag of the tool 66.

Referring now to FIG. 11, the system 10 determines the location associated with each of the response signals via the data structure 48. The system 10 also determines the description associated with each of the identification codes of the response signals via the data structure 50.

Referring again to FIGS. 2, 10 and 11, a comparison performed by the system 10 of the assets identified for the job “Framing”, i.e., “Drill,” “Hammer,” “Level” and “Nail Gun,” with the assets located in the vicinity of the vehicle 8, i.e., “Drill,” “Hammer” and “Level,” reveals that the “Nail Gun” is missing from the vehicle 8. The information regarding the assets is provided via the display 16n.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An asset management system for an automotive vehicle, the system comprising:
a detection module configured to detect signals from wireless identification tags associated with assets in a vicinity of the vehicle, the signals being indicative of identifiers embedded in the wireless identification tags;
a processor module configured to (i) identify assets to perform a specified task and (ii) determine whether each of the assets to perform the specified task is located within the vicinity of the vehicle based on the identifiers; and
an interface module configured to (i) receive input specifying one or more assets for one or more tasks, (ii) receive input specifying a task and (iii) provide output indicating whether the assets to perform the specified task are located within the vicinity of the vehicle, as determined by the processor module.

2. The system of claim 1 wherein the processor module identifies the assets to perform the specified task via a data structure that maps each of a plurality of tasks with a set of assets to perform the task.

3. The system of claim 1 wherein the detection module is further configured to generate a signal to energize the wireless identification tags associated with the assets in the vicinity of the vehicle.

4. The system of claim 3 wherein the processor module determines whether each of the assets to perform the specified task is located within the vicinity of the vehicle by comparing the assets identified to perform the specified task with the assets in the vicinity of the vehicle.

5. The system of claim 1 wherein the interface module is remote from the vehicle.

6. The system of claim 1 wherein the processor module is further configured to determine whether the assets located within the vicinity of the vehicle are located within a predefined region of the vehicle.

7. The system of claim 1 wherein the processor module is further configured to periodically activate the detection module to inventory the assets in the vicinity of the vehicle.

8. The system of claim 1 wherein the processor module is further configured to determine whether an asset in the vicinity of the vehicle is removed from the vicinity of the vehicle and wherein the interface module is further configured to provide output indicating that an asset in the vicinity of the vehicle has been removed from the vicinity of the vehicle.

9. The system of claim 1 wherein the interface module is further configured to receive input querying the location of a selected asset and wherein the processor module is further configured to determine whether the selected asset is within the vicinity of the vehicle.

10. An asset management system for an automotive vehicle, the system comprising:
one or more radio frequency transmitters configured to generate signals that energize wireless identification tags associated with assets in a vicinity of the vehicle;
one or more radio frequency receivers configured to detect signals indicative of identifiers embedded in the energized wireless identification tags;
a computer configured to (i) identify assets to perform a specified task and (ii) determine whether each of the assets to perform the specified task is located within the vicinity of the vehicle based on the identifiers; and
an interface configured to (i) receive input specifying one or more assets for one or more tasks, (ii) receive input specifying a task and (iii) provide output indicating whether the assets to perform the specified task are within the vicinity of the vehicle, as determined by the computer.

11. The system of claim 10 wherein the computer includes a memory having a data structure stored therein, wherein the data structure maps each of a plurality of tasks with a set of assets to perform the task and wherein the computer identifies the assets to perform the specified task via the data structure.

12. The system of claim 10 wherein the interface comprises at least one of a mobile computing device, a cell phone and a desk top computer remote from the vehicle.

13. The system of claim 10 wherein the computer is further configured to determine whether the assets located within the vicinity of the vehicle are located within a predefined region of the vehicle.

14. The system of claim 10 wherein the computer is further configured to periodically activate the plurality of radio frequency transmitters to inventory the assets in the vicinity of the vehicle.

15. The system of claim 10 wherein the computer is further configured to determine whether an asset in the vicinity of the vehicle is removed from the vicinity of the vehicle and wherein the interface is further configured to provide output indicating that an asset in the vicinity of the vehicle has been removed from the vicinity of the vehicle.

16. A method for locating assets to perform a task in a vicinity of a vehicle, each of the assets being equipped with a wireless identification tag embedded with an asset identifier, the method comprising:
receiving input specifying one or more assets to one or more tasks;
receiving input specifying a task;
detecting signals from wireless identification tags associated with assets in a vicinity of a vehicle, the signals being indicative of identifiers embedded in the wireless identification tags;
determining whether each of the assets to perform the specified task is located within the vicinity of the vehicle based on the identifiers; and
providing output indicating whether the assets to perform the specified task are located within the vicinity of the vehicle.

17. The method of claim 16 further comprising generating a signal to energize the wireless identification tags.

18. The method of claim 16 wherein determining whether each of the assets to perform the specified task is located within the vicinity of the vehicle includes comparing the assets identified to perform the specified task with the assets in the vicinity of the vehicle.

19. The method of claim 16 further comprising determining whether the assets located within the vicinity of the vehicle are located within a predefined region of the vehicle.

20. The method of claim 16 further comprising generating an alert if an asset located within the vicinity of the vehicle is removed from the vicinity of the vehicle.
